(19) United States
(12) Patent Application Publication
(10) Pub. No.: US 2014/0367144 A1
(43) Pub. Date: Dec. 18, 2014

(54) HALOGEN-FREE FLAME-RETARDANT RESIN COMPOSITION, AND WIRE AND CABLE USING THE SAME

(71) Applicant: Hitachi Metals, Ltd., Tokyo (JP)

(72) Inventors: Kentaro SEGAWA, Kudamatsu (JP); Makoto Iwasaki, Hitachi (JP); Yoshiaki Nakamura, Hitachi (JP)

(21) Appl. No.: 14/303,185

(22) Filed: Jun. 12, 2014

(30) Foreign Application Priority Data
Jun. 14, 2013 (JP) 2013-125618

(51) Int. Cl. H01B 3/02; H01B 7/295; H01B 7/00; H01B 3/44

(52) U.S. Cl. CPC H01B 3/02; H01B 3/441; H01B 3/448; H01B 7/295; H01B 7/0045
USPC 174/113 R; 524/436; 428/389

(57) ABSTRACT

A halogen-free flame-retardant resin composition includes a base polymer including not less than 5 mass % of an ethylene-α-olefin block copolymer having a melting point of not less than 118° C. and a glass transition temperature (Tg) of not more than −40° C., and a metal hydroxide added in an amount of 50 to 250 parts by mass per 100 parts by mass of the base polymer.

The present application is based on Japanese patent application No. 2013-125618 filed on Jun. 14, 2013, the entire contents of which are incorporated herein by reference.

### BACKGROUND OF THE INVENTION

1. Field of the Invention

The invention relates to a halogen-free flame-retardant resin composition and a wire and a cable using the halogen-free flame-retardant resin composition. In more detail, the invention relates to a halogen-free flame-retardant resin composition that is excellent in flame retardancy, oil resistance and low-temperature resistance, and a wire and a cable using the halogen-free flame-retardant resin composition.

2. Description of the Related Art

Used as a flame-retardant resin composition without any halogen compound (i.e. halogen-free) is a composition that a metal hydroxide such as a magnesium hydroxide is added to a polyolefin-based resin. This does not produce poisonous gas such as hydrogen chloride or dioxin when being burnt and thus prevents toxic gas production and resulting secondary disaster etc. in the event of fire, and also, no problem arises even if incinerated for disposal. In general, the halogen-free flame-retardant resin composition is prepared by mixing a large amount of a halogen-free flame retardant such as a magnesium hydroxide to a polyolefin-based resin. When a large amount of the halogen-free flame retardant is mixed thereto so as to improve the flame retardancy, a problem may arise that mechanical characteristics such as elongation decrease and the intended wires are not obtained. Especially automotive wires further need to have excellent oil resistance and low-temperature resistance. Although a material having high crystallinity such as a polyethylene is sometimes used as a base polymer to meet the oil resistance, it tends to be more difficult to add the halogen-free flame retardant since the non-crystalline portion decreases.

Thus, a halogen-free resin composition has been proposed in which oil resistance and mechanical characteristics are improved by increasing the polar moieties of a base polymer (see e.g. JP-A-2007-161814).

### SUMMARY OF THE INVENTION

The resin composition disclosed in JP-A-2007-161814 has a problem that it may have an increased glass transition temperature (Tg) due to many polar moieties and an insufficient low-temperature resistance, so that it cannot be used as a wire insulation material and a cable sheath material etc. at low temperature.

It is an object of the invention to provide a halogen-free flame-retardant resin composition that is excellent in the flame retardancy, oil resistance and low-temperature resistance, as well as a wire and a cable using the halogen-free flame-retardant resin composition.

(1) According to one embodiment of the invention, a halogen-free flame-retardant resin composition comprises:

a base polymer comprising not less than 5 mass % of an ethylene-α-olefin block copolymer having a melting point of not less than 118° C. and a glass transition temperature (Tg) of not more than −40° C.; and

a metal hydroxide added in an amount of 50 to 250 parts by mass per 100 parts by mass of the base polymer.

In the above embodiment (1) of the invention, the following modifications and changes can be made.

(i) An α-olefin constituting the ethylene-α-olefin block copolymer comprises 1-octene.

(ii) The base polymer further comprises 5 to 40 mass % of polyethylene and maleic anhydride-modified ethylene-α-olefin copolymer.

(2) According to another embodiment of the invention, a halogen-free flame-retardant wire comprises:

a conductor; and

an insulation formed by covering an outer periphery of the conductor with the halogen-free flame-retardant resin composition according to the above embodiment (1).

(3) According to another embodiment of the invention, a halogen-free flame-retardant cable comprises:

a plurality of bundled wires each comprising a conductor and an insulation; and

a sheath formed by covering an outer periphery of the plurality of bundled wires with the halogen-free flame-retardant resin composition according to the above embodiment (1).

### EFFECTS OF THE INVENTION

According to one embodiment of the invention, a halogen-free flame-retardant resin composition can be provided that is excellent in the flame retardancy, oil resistance and low-temperature resistance, as well as a wire and a cable using the halogen-free flame-retardant resin composition.

### BRIEF DESCRIPTION OF THE DRAWINGS

Next, the present invention will be explained in more detail in conjunction with appended drawings, wherein:

FIG. 1 is a schematic cross sectional view showing a cable in an embodiment of the present invention (a cable formed by providing a sheath to cover the outer periphery of plural wires each provided with a conductor and an insulation formed to cover the outer periphery of the conductor); and

FIG. 2 is a schematic cross sectional view showing a wire in the embodiment of the invention (a wire provided with a conductor and an insulation formed to cover the outer periphery of the conductor).

### DETAILED DESCRIPTION OF THE PREFERRED EMBODIMENT

### Summary of Embodiment

A halogen-free flame-retardant resin composition in the present embodiment contains a base polymer and a metal hydroxide. The base polymer includes not less than 5 mass % of ethylene-α-olefin block copolymer having a melting point of not less than 118° C. and a glass transition temperature (Tg) of not more than −40° C. The metal hydroxide is mixed in an amount of 50 to 250 parts by mass per 100 parts by mass of the base polymer.

Meanwhile, a halogen-free flame-retardant wire in the present embodiment is provided with a conductor and an insulation formed by covering the outer periphery of the conductor with the halogen-free flame-retardant resin composition described above.

Furthermore, a halogen-free flame-retardant cable in the present embodiment is provided with plural bundled wires, each composed of a conductor and an insulation, and a sheath formed by covering the outer periphery of the plural bundled wires with the halogen-free flame-retardant resin composition described above.

### Embodiment

An embodiment of a halogen-free flame-retardant resin composition of the invention and a wire and a cable using the same will be specifically described below in reference to the drawings.

### I. Halogen-Free Flame-Retardant Resin Composition

The halogen-free flame-retardant resin composition in the present embodiment includes a base polymer including not less than 5 mass % of ethylene-α-olefin block copolymer having a melting point of not less than 118° C. and a glass transition temperature (Tg) of not more than −40° C., and also includes a metal hydroxide mixed in an amount of 50 to 250 parts by mass per 100 parts by mass of the base polymer. Each component will be specifically described below.

### 1. Base Polymer

As described above, the base polymer of the halogen-free flame-retardant resin composition in the present embodiment is configured to include not less than 5 mass % of ethylene-α-olefin block copolymer having a melting point of not less than 118° C. and a glass transition temperature (Tg) of not more than −40° C.

### (1-1) Ethylene-α-Olefin Block Polymer

Ethylene-α-olefin block copolymer constituting the base polymer used in the present embodiment needs to have a melting point of not less than 118° C. The amount of crystals is not enough when less than 118° C., which results in a decrease in oil resistance.

The ethylene-α-olefin block copolymer in the present embodiment needs to have a glass transition temperature (Tg) of not more than −40° C., preferably, not more than −50° C. Low-temperature resistance (elongation) decreases when higher than −40° C.

In the present embodiment, the amount of the ethylene-α-olefin block copolymer mixed in the base polymer is not less than 5 mass %. Oil resistance and mechanical characteristics decrease when less than 5 mass %.

The ethylene-α-olefin block copolymer in the present embodiment exemplarily has a Shore A hardness of not more than 85, more preferably, not more than 75. Mechanical characteristics (elongation) may decrease when more than 85.

Examples of α-olefin constituting the ethylene-α-olefin block copolymer in the present embodiment include propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene and 1-eicosene, etc. Of those, 1-octene is exemplary from the viewpoint of mechanical characteristics.

The ethylene-α-olefin block copolymer in the present embodiment allows an increase in the melting point because it is a block polymer, which is advantageous to improve oil resistance. In case of random copolymer, it is thus difficult to improve oil resistance since crystallinity of the material is impaired and a melting point is lowered.

### (1-2) Other Copolymer Components

Copolymer components constituting the base polymer used in the present embodiment, other than the ethylene-α-olefin block copolymer, can be at least one selected from the group consisting of, e.g., polyethylene (low-density polyethylene (LDPE), linear low-density polyethylene (LLDPE) and linear very low-density polyethylene (VLDPE)), ethylene-methyl methacrylate copolymer (EMMA), ethylene-ethyl methacrylate copolymer (EEMA), ethylene vinyl acetate copolymer (EVA), ethylene-styrene copolymer, maleic anhydride-modified ethylene-α-olefin copolymer and maleic acid grafted linear low-density polyethylene. Among the above, polyethylene and maleic anhydride-modified ethylene-α-olefin copolymer are exemplary from the viewpoint of oil resistance and low-temperature resistance. The amount of these copolymer components mixed in the base polymer is preferably 5 to 40 mass %, more preferably, 10 to 30 mass %.

### 2. Metal Hydroxide

Examples of metal hydroxide (halogen-free flame retardant) used for the halogen-free flame-retardant resin composition in the present embodiment include magnesium hydroxide, aluminum hydroxide, calcium hydroxide, and these hydroxides with dissolved nickel. These hydroxides can be used alone or as a mixture of two or more thereof.

In addition, these metal hydroxides may be used after surface treatment with a silane coupling agent, titanate-based coupling agent, fatty acid such as stearic acid or calcium stearate, or fatty acid metal salt, etc. In addition, other metal hydroxides may be added in an appropriate amount.

The mixed amount of the metal hydroxide needs to be 50 to 250 parts by mass, preferably, 150 to 200 parts by mass. Sufficient flame retardancy is not obtained when less than 50 parts by mass while mechanical characteristics decrease when more than 250 parts by mass.

### 3. Other Components to be Mixed

To the halogen-free flame-retardant resin composition in the present embodiment, it is possible, if necessary, to mix other components such as antioxidants, lubricants, softeners, plasticizers, inorganic fillers, compatibilizing agents, stabilizers, carbon black and colorants in addition to the above-mentioned base polymer and metal hydroxides. In addition, flame-retardant aids may be mixed within a range not impairing characteristics of the invention to further improve performance.

The halogen-free flame-retardant resin composition in the present embodiment is exemplarily crosslinked from the viewpoint of improving mechanical characteristics. The cross-linking method can be, e.g., an electron beam crosslinking in which an electron beam is irradiated after molding or a chemical cross-linking method in which a halogen-free flame-retardant resin composition with a pre-mixed cross-linking agent is crosslinked by heating after molding.

### II. Halogen-Free Flame-Retardant Wire

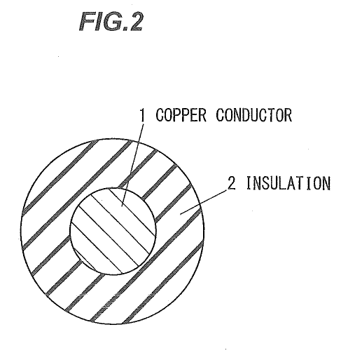

The halogen-free flame-retardant wire in the present embodiment is composed of a copper conductor 1 and an insulation 2 formed by covering the outer periphery of the copper conductor 1 with the halogen-free flame-retardant resin composition described above, as shown in FIG. 2.

### III. Halogen-Free Flame-Retardant Cable

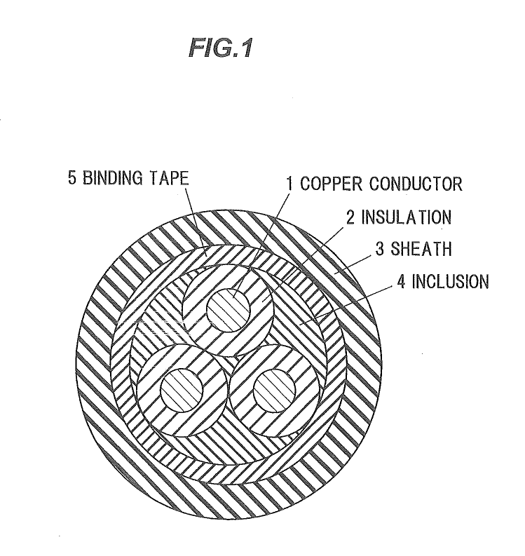

As shown in FIG. 1, the cable in the present embodiment is composed of plural bundled (twisted) wires each provided with the copper conductor 1 and the insulation 2 formed to cover the outer periphery of the copper conductor 1, a holding member, e.g., a binding tape 5, which is wound together with, e.g., a paper inclusion 4 around the outer periphery of the plural twisted wires, and a sheath 3 formed by covering the outer periphery of the binding tape 5 with the halogen-free flame-retardant resin composition described above. In this case, it is exemplary that the insulation 2 be formed of the halogen-free flame-retardant resin composition described above.

### EXAMPLES

The halogen-free flame-retardant resin composition of the invention and the wire and the cable using the same will be described more specifically below in reference to Examples. It should be noted that the following Examples are not intended to limit the invention in any way.

### Example 1

The following components were mixed in the amounts described below (or see Table 1).

50 parts by mass of ethylene-α-olefin block copolymer (trade name: INFUSE9100 manufactured by The Dow Chemical Company, Melting point: 120° C., Glass transition temperature (Tg): −62° C., Shore A hardness: 75) as the base polymer;
20 parts by mass of maleic anhydride graft-modified ethylene/butene copolymer (EBR) (trade name: TAFMER MHSO40 manufactured by Mitsui Chemicals, Melting point: 66° C., Glass transition temperature (Tg): −50° C., Shore A hardness: 60) as the base polymer;
10 parts by mass of ethylene-vinyl acetate copolymer (EVA) (trade name: Evaflex 45LX manufactured by Du Pont-Mitsui Polychemicals Co., Ltd., VA content: 46%, Glass transition temperature (Tg): −26° C., Shore A hardness: 31) as the base polymer;
20 parts by mass of linear low-density polyethylene (LLDPE) (trade name: Evolue SP1510 manufactured by Prime Polymer Co., Ltd., Melting point: 118° C., Glass transition temperature (Tg): −110° C., Shore A hardness: 100) as the base polymer;
180 parts by mass of magnesium hydroxide (trade name: Magseeds S4 manufactured by Konoshima Chemical Co., Ltd.) as metal hydroxide;
10 parts by mass of silica (trade name: SIDISTAR T120U manufactured by Elkem AS) as a flame-retardant aid;
2 parts by mass of trimethylolpropane triacrylate (trade name: TMPT manufactured by Shin-Nakamura Chemical Co., Ltd.) as a crosslinking aid;
1 part by mass of antioxidant A (trade name: ADK STAB AO-18 manufactured by ADEKA Corporation) as an antioxidant;
2 parts by mass of antioxidant B (trade name: Irganox1010 manufactured by BASF) as an antioxidant;
1 part by mass of zinc stearate (trade name: EZ101 manufactured by Katsuta Kako Co., Ltd.) as a lubricant; and
5 parts by mass of carbon black (trade name: Asahi Thermal FT manufactured by Asahi Carbon Co., Ltd.) as a colorant.

The components mixed in the amounts shown above were kneaded by a 25-liter pressure kneader at a start temperature of 40° C. and an end temperature of 200° C. and the kneaded mixture was then pelletized, thereby obtaining a resin composition.

Using a 65-mm extruder, the obtained resin composition was extrusion-molded on the outer periphery of the copper conductor 1 having an outer diameter of 1.1 mm at a preset temperature of 200° C. to form a 0.7 mm-thick insulation 2 as shown in FIG. 2, and 4 Mrad of electron beam was subsequently irradiated to cross-link, thereby making an electric wire.

As shown in FIG. 1, three wires each formed as described above were twisted together with paper inclusion 4, the binding tape 5 was provided thereon, the resin composition obtained as described above was extrusion-molded on the outer periphery thereof to form a 1.0 mm-thick sheath 3, and 4 Mrad of electron beam was subsequently irradiated to cross-link, thereby making a cable.

Table 1 shows the mixed components of the halogen-free flame-retardant resin composition used in Example 1 and also shows below-described evaluation results of wires.

### Examples 2 to 7

Samples were made in the same manner as Example 1 except that the components mixed in the halogen-free flame-retardant resin composition were changed to those shown in Table 1. The evaluation results of the wires are shown in Table 1.

### Comparative Examples 1 to 5

Samples were made in the same manner as Example 1 except that the components mixed in the halogen-free flame-retardant resin composition were changed to those shown in Table 2. The evaluation results of the wires are shown in Table 2.

### Evaluation Method of Wire

The wires were evaluated and judged by the evaluation tests described below.

### (1) Tensile Test

A tensile test was conducted on the obtained electric wires in accordance with EN 60811-1-1. With targets of not less than 10 MPa of tensile strength and not less than 150% of elongation, the wires which achieved the targets were regarded as “◯ (passed the test)” and those which did not achieve the targets were regarded as “ [symbol] (failed the test)”.

### (2) Flame-Retardant Test

A vertical flame test was conducted on the obtained electric wires in accordance with EN 60332-1-2. The wires passed the test (◯) when a distance between a lower edge of an upper support member and a carbonized portion after flame extinction was not less than 50 mm, and the wires failed the test ( [symbol] ) when the distance was less than 50 mm.

### (3) Oil Resistance Test

In accordance with EN 60811-1-3, the obtained electric wires were immersed in test oil IRM 902, were heated in a constant-temperature oven at 100° C. for 72 hours and were then left at room temperature for about 16 hours. Then, a tensile test was conducted and a value after oil immersion and heating (percentage of retention) with respect to the initial value was evaluated. With targets of not less than 70% of tensile strength retention and not less than 60% of elongation retention, the wires which achieved the targets were regarded as “◯ (passed)” and those which did not achieve the targets were regarded as “ [symbol] (failed)”.

### (4) Low-Temperature Resistance Test

In accordance with EN 60811-1-4 8.1, a cold bending test was conducted on the obtained electric wire at −40° C. The wires in which cracks were not generated at the time of bending were regarded as “◯ (passed)”, and those in which cracks were generated were regarded as “ [symbol] (failed)”.

As shown in Table 1, Examples 1 to 7 passed all characteristics tests of the tensile test, the flame-retardant test, the oil resistant test and the low-temperature resistant test.

Meanwhile, as shown in Table 2, Comparative Example 1, in which the mixed amount of magnesium hydroxide (45 parts by mass) was less than the amount defined in the invention (50 to 250 parts by mass), failed the flame retardancy test. On the other hand, Comparative Example 2, in which the mixed amount of magnesium hydroxide (255 parts by mass) was more than the amount defined in the invention, failed the elongation characteristics test. Comparative Example 3, in which the melting point of the ethylene-α-olefin block copolymer (115° C.) was lower than that defined in the invention (118° C.), failed the oil resistance test. Comparative Example 4, in which the mixed amount of ethylene-α-olefin block copolymer (4 mass %) was less than that defined in the invention (not less than 5 mass %), failed the elongation test. Comparative Example 5, in which the mixed amount of ethylene-α-olefin block copolymer (4 mass %) was less than that defined in the invention (not less than 5 mass %), failed the low-temperature resistance test.

TABLE 1

| | | | | Examples | | | |
|---|---|---|---|---|---|---|---|
| | | Materials | Characteristics | 1 | 2 | 3 | 4 |
| Components | Base polymer | Ethylene-α-olefin block | Melting point: 120° C., Tg: −62° C., | 50 | 20 | 5 | 80 |
| | | copolymer *1 | Shore A hardness: 75 | | | | |
| | | Ethylene-α-olefin block | Melting point: 118° C., Tg: −62° C., | — | — | — | — |
| | | copolymer *2 | Shore A hardness: 55 | | | | |
| | | Ethylene-α-olefin block | Melting point: 119° C., Tg: −62° C., | | | | |
| | | copolymer *3 | Shore A hardness: 83 | | | | |
| | | Maleic anhydride-modified | Melting point: 66° C., Tg: −50° C., | 20 | 20 | 20 | 5 |
| | | EBR *4 | Shore A hardness: 60 | | | | |
| | | EVA *5 | VA content: 46%, Tg: −26° C., | 10 | 10 | 10 | 15 |
| | | | Shore A hardness: 31 | | | | |
| | | LLDPE *6 | Melting point: 118° C., Tg: −110° C., | 20 | 50 | 65 | — |
| | | | Shore A hardness: 100 | | | | |
| | Metal hydroxide | Magnesium hydroxide *7 | | 180 | 180 | 180 | 180 |
| | Flame-retardant aid | Silica *8 | | 10 | 10 | 10 | 10 |
| | Crosslinking aid | Trimethylolpropane | | 2 | 2 | 2 | 2 |
| | | triacrylate *9 | | | | | |
| | Antioxidant | Antioxidant A *10 | | 1 | 1 | 1 | 1 |
| | | Antioxidant B *11 | | 2 | 2 | 2 | 2 |
| | Lubricant | Zinc stearate *12 | | 1 | 1 | 1 | 1 |
| | Colorant | Carbon black *13 | | 5 | 5 | 5 | 5 |
| Evaluation tests | Tensile test | Tensile strength (MPa) | Target: not less than 10 MPa | ◯ | ◯ | ◯ | ◯ |
| | | | | 13.2 | 20.6 | 21.5 | 11.2 |
| | | Elongation (%) | Target: not less than 150% | ◯ | ◯ | ◯ | ◯ |
| | | | | 227 | 173 | 150 | 317 |
| | Flame retardant test | | Target: Pass (◯) | ◯ | ◯ | ◯ | ◯ |
| | Oil resistance test | Tensile strength retention (%) | Target: not less than 70% | ◯ | ◯ | ◯ | ◯ |
| | | | | 80 | 75 | 73 | 81 |
| | | Elongation retention (%) | Target: not less than 60% | ◯ | ◯ | ◯ | ◯ |
| | | | | 85 | 79 | 70 | 73 |
| | Low-temperature resistance test | | Target: Pass (◯) | ◯ | ◯ | ◯ | ◯ |
| | | Evaluation | | ◯ | ◯ | ◯ | ◯ |
| | | | | Examples | | | |
| | | Materials | Characteristics | 5 | 6 | 7 | 8 |
| Components | Base polymer | Ethylene-α-olefin block | Melting point: 120° C., Tg: −62° C., | — | 50 | 50 | |
| | | copolymer *1 | Shore A hardness: 75 | | | | |
| | | Ethylene-α-olefin block | Melting point: 118° C., Tg: −62° C., | 50 | — | — | |
| | | copolymer *2 | Shore A hardness: 55 | | | | |
| | | Ethylene-α-olefin block | Melting point: 119° C., Tg: −62° C., | | | | 100 |
| | | copolymer *3 | Shore A hardness: 83 | | | | |
| | | Maleic anhydride-modified | Melting point: 66° C., Tg: −50° C., | 20 | 20 | 20 | |
| | | EBR *4 | Shore A hardness: 60 | | | | |
| | | EVA *5 | VA content: 46%, Tg: −26° C., | 10 | 10 | 10 | |
| | | | Shore A hardness: 31 | | | | |
| | | LLDPE *6 | Melting point: 118° C., Tg: −110° C., | 20 | 20 | 20 | |
| | | | Shore A hardness: 100 | | | | |
| | Metal hydroxide | Magnesium hydroxide *7 | | 180 | 50 | 250 | 250 |
| | Flame-retardant aid | Silica *8 | | 10 | 10 | 10 | 10 |
| | Crosslinking aid | Trimethylolpropane | | 2 | 2 | 2 | 2 |
| | | triacrylate *9 | | | | | |
| | Antioxidant | Antioxidant A *10 | | 1 | 1 | 1 | 1 |
| | | Antioxidant B *11 | | 2 | 2 | 2 | 2 |
| | Lubricant | Zinc stearate *12 | | 1 | 1 | 1 | 1 |
| | Colorant | Carbon black *13 | | 5 | 5 | 5 | 5 |
| Evaluation tests | Tensile test | Tensile strength (MPa) | Target: not less than 10 MPa | ◯ | ◯ | ◯ | ◯ |
| | | | | 11.8 | 17.5 | 18.7 | 10.0 |
| | | Elongation (%) | Target: not less than 150% | ◯ | ◯ | ◯ | ◯ |
| | | | | 253 | 353 | 150 | 700 |
| | Flame retardant test | | Target: Pass (◯) | ◯ | ◯ | ◯ | ◯ |
| | Oil resistance test | Tensile strength retention (%) | Target: not less than 70% | ◯ | ◯ | ◯ | ◯ |
| | | | | 70 | 81 | 80 | 82 |
| | | Elongation retention (%) | Target: not less than 60% | ◯ | ◯ | ◯ | ◯ |
| | | | | 62 | 83 | 79 | 75 |

| | | | | | |
|---|---|---|---|---|---|
| Low-temperature resistance test | Target: Pass (◯) | ◯ | ◯ | ◯ | ◯ |

| | | | | |
|---|---|---|---|---|
| Evaluation | ◯ | ◯ | ◯ | ◯ |

*1 Trade name: INFUSE9100 from Dow Chemical
*2 Trade name: INFUSE9807 from Dow Chemical
*3 Trade name: INFUSE9530 from Dow Chemical
*4 Trade name: TAFMER MH5040 from Mitsui Chemicals
*5 Trade name: Evaflex 45LX from Du Pont-Mitsui Polychemicals
*6 Trade name: Evolue SP1510 from Prime Polymer
*7 Trade name: Magseeds S4 from Konoshima Chemical
*8 Trade name: SIDISTAR T120U from Elkem AS
*9 Trade name: TMPT from Shin-Nakamura Chemical
*10 Trade name: ADK STAB AO-18 from ADEKA
*11 Trade name: Irganox1010 from BASF
*12 Trade name: EZ101 from Katsuta Kako
*13 Trade name: Asahi Thermal FT from Asahi Carbon

TABLE 2

| | | | | Comparative Examples | | | | |
|---|---|---|---|---|---|---|---|---|
| | | Materials | Characteristics | 1 | 2 | 3 | 4 | 5 |
| Components | Base polymer | Ethylene-α-olefin block | Melting point: 120° C., Tg: −62° C., | 50 | 50 | — | 4 | 4 |
| | | copolymer *1 | Shore A hardness: 75 | | | | | |
| | | Ethylene-α-olefin block | Melting point: 115° C., Tg: −100° C., | — | — | 50 | — | — |
| | | copolymer *14 | Shore A hardness: 90 | | | | | |
| | | Maleic anhydride- | Melting point: 66° C., Tg: −50° C., | 20 | 20 | 20 | — | — |
| | | modified EBR *4 | Shore A hardness: 60 | | | | | |
| | | EVA *5 | VA content: 46%, Tg: −26° C., | 10 | 10 | 10 | — | 96 |
| | | | Shore A hardness: 31 | | | | | |
| | | LLDPE *6 | Melting point: 118° C., Tg: −110° C., | 20 | 20 | 20 | 96 | — |
| | | | Shore A hardness: 100 | | | | | |
| | Metal hydroxide | Magnesium hydroxide *7 | | 45 | 255 | 180 | 180 | 180 |
| | Flame-retardant aid | Silica *8 | | 10 | 10 | 10 | 10 | 10 |
| | Crosslinking aid | Trimethylolpropane triacrylate *9 | | 2 | 2 | 2 | 2 | 2 |
| | Antioxidant | Antioxidant A *10 | | 1 | 1 | 1 | 1 | 1 |
| | | Antioxidant B *11 | | 2 | 2 | 2 | 2 | 2 |
| | Lubricant | Zinc stearate *12 | | 1 | 1 | 1 | 1 | 1 |
| | Colorant | Carbon black *13 | | 5 | 5 | 5 | 5 | 5 |
| Evaluation tests | Tensile test | Tensile strength (MPa) | Target: not less than 10 MPa | ◯ | ◯ | ◯ | ◯ | ◯ |
| | | | | 17.8 | 18.9 | 15.4 | 22.9 | 11.5 |
| | | Elongation (%) | Target: not less than 150% | ◯ | X | ◯ | X | ◯ |
| | | | | 350 | 147 | 203 | 147 | 333 |
| | Flame retardant test | | Target: Pass (◯) | X | ◯ | ◯ | ◯ | ◯ |
| | Oil resistance test | Tensile strength retention (%) | Target: not less than 70% | ◯ | ◯ | X | ◯ | ◯ |
| | | | | 82 | 78 | 68 | 72 | 77 |
| | | Elongation retention (%) | Target: not less than 60% | ◯ | ◯ | X | ◯ | ◯ |
| | | | | 80 | 77 | 59 | 63 | 68 |

| | | | | | | |
|---|---|---|---|---|---|---|
| Low-temperature resistance test | Target: Pass (◯) | ◯ | ◯ | ◯ | ◯ | X |

| | | | | | |
|---|---|---|---|---|---|
| Evaluation | X | X | X | X | X |

*1 Trade name: INFUSE9100 from Dow Chemical
*4 Trade name: TAFMER MH5040 from Mitsui Chemicals
*5 Trade name: Evaflex 45LX from Du Pont-Mitsui Polychemicals
*6 Trade name: Evolue SP1510 from Prime Polymer
*7 Trade name: Magseeds S4 from Konoshima Chemical
*8 Trade name: SIDISTAR T120U from Elkem AS
*9 Trade name: TMPT from Shin-Nakamura Chemical
*10 Trade name: ADK STAB AO-18 from ADEKA
*11 Trade name: Irganox1010 from BASF
*12 Trade name: EZ101 from Katsuta Kako
*13 Trade name: Asahi Thermal FT from Asahi Carbon
*14 Trade name: Excellen VL100 from Sumitomo Chemical

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A halogen-free flame-retardant resin composition, comprising:
a base polymer comprising not less than 5 mass % of an ethylene-α-olefin block copolymer having a melting point of not less than 118° C. and a glass transition temperature (Tg) of not more than −40° C.; and
a metal hydroxide added in an amount of 50 to 250 parts by mass per 100 parts by mass of the base polymer.

2. The halogen-free flame-retardant resin composition according to claim 1, wherein the ethylene-α-olefin block copolymer has a Shore A hardness of not more than 85.

3. The halogen-free flame-retardant resin composition according to claim 1, wherein an α-olefin constituting the ethylene-α-olefin block copolymer comprises 1-octene.

4. The halogen-free flame-retardant resin composition according to claim 1, wherein the base polymer further comprises 5 to 40 mass % of polyethylene and maleic anhydride-modified ethylene-α-olefin copolymer.

5. A halogen-free flame-retardant wire, comprising:
a conductor; and
an insulation formed by covering an outer periphery of the conductor with the halogen-free flame-retardant resin composition according to claim 1.

6. A halogen-free flame-retardant cable, comprising:
a plurality of bundled wires each comprising a conductor and an insulation; and
a sheath formed by covering an outer periphery of the plurality of bundled wires with the halogen-free flame-retardant resin composition according to claim 1.
